(19) United States
(12) Patent Application Publication
(10) Pub. No.: US 2001/0045108 A1
(43) Pub. Date: Nov. 29, 2001

(54) Method for molding a shaped optical fiber tip

(76) Inventors: Dan A. Steinberg, Blacksburg, VA (US); Mindaugas F. Dautartas, Blacksburg, VA (US); John Fisher, Blacksburg, VA (US); Martin G. Meder, Blacksburg, VA (US)

Correspondence Address: HALEOS, INC., 3150 STATE STREET, BLACKSBURG, VA, 24060, US

(21) Appl. No.: 09/681,969

(22) Filed: Jul. 2, 2001

Related U.S. Application Data
(60) Provisional application No. 60/255,766, filed on Dec. 14, 2000.

(51) Int. Cl. C03B 37/07

(52) U.S. Cl. 65/378; 65/391; 65/425; 65/485

(57) ABSTRACT

A method for shaping an end of an optical fiber having a core to provide a novel optical fiber (or waveguide) includes the steps of contacting the fiber against a mold having a predetermined shape, The fiber and/or mold is heated. The fibers can be made of silica. The method is well suited for making wedge-shaped (i.e., standard screwdriver-like shaped) fiber tips. In addition, an apparatus for molding a shaped tip precisely located with respect to a core of an optical fiber includes a mold having one or more surfaces of the mold being configured and dimensioned to impart a predetermined shape to an end of an optical fiber contacted therewith, the predetermined shape being precisely located with respect to the core of the optical fiber.

### CROSS REFERENCE TO RELATED APPLICATIONS

This application claims priority to U.S. Provisional Application Ser. No. 60/255,766, filed Dec. 14, 2000.

### BACKGROUND OF THE INVENTION

1. Technical Field

This disclosure relates to shaped optical fiber tips. More particularly, this disclosure relates to a method for forming a shaped optical fiber tip having good alignment between the waveguide core and the shaped tip.

2. Description of Related Art

An optical communication system includes a source of light energy (such as, for example, electromagnetic radiation) and an associated receiver connected over an optical fiber waveguide.

A typical optical fiber has a core formed of a material having a first predetermined index of refraction. The core is surrounded by an outer layer of a cladding material having a second predetermined index of refraction. The overall outer diameter of an optical fiber is typically on the order of about one hundred twenty five (125) micrometers.

In order for light to enter into an optical fiber waveguide, the axis of which is the optical transmission path, coupling is generally performed by aligning the end of an optical fiber with the source of light energy. The pattern of the light emitted by the source, e.g., circular, elliptical, etc., depends on the type of light source employed. The optical fiber frequently is shaped at its tip to more accurately match the pattern of light emitted by the light source. For example, fibers with wedge shaped tips are useful for coupling optical fiber waveguides to semiconductor lasers, e.g., edge-emitting lasers, and similar devices that emit a noncircular beam shape.

However, wedge shaped optical fiber tips are difficult to fabricate with accuracy, requiring a number of distinct labor intensive steps. It is also extremely important that the waveguide core of the optical fiber be precisely located with respect to the wedge shape of the optical fiber tip.

For example, if the waveguide core and wedge shape are not aligned, then the fiber is not parallel with its own far-field optical axis, and very poor optical coupling results. Thus, for example, where a wedge shape is generated by lapping two sides of an optical fiber, unacceptable misalignment results if even one side is overlapped by a few microns.

It would be advantageous if shaping the tip of an optical fiber could be achieved efficiently and accurately by a simple process.

### SUMMARY OF THE INVENTION

Novel optical fibers with tips shaped by molding are described herein. The novel optical fibers have a molded shape at an end thereof, the molded shape being precisely located with respect to the core. These novel optical fibers are particularly useful for receiving light emitted from a device having a noncircular beam shape, such as occurs with light emitted from edge-emitting semiconductor lasers. Methods for making the novel optical fibers with tips shaped by molding are also described. Methods according to this disclosure consistently result in optical fibers having shaped tips that are precisely located with respect to the waveguide core.

Thus, the present method for shaping an end of an optical fiber having a core includes the steps of contacting an end of an optical fiber with a mold having a recess of predetermined shape and maintaining the end of the optical fiber in contact with the mold until at least a portion of the fiber conforms to the predetermined shape of the recess to produce a shaped tip on the end of the fiber, the core of the fiber being precisely located with respect to the shaped tip, the mold or the optical fiber or both being heated before and/or during the contacting step. Empirical observations can be made during the contacting step to ensure the accuracy of fiber positioning with appropriate adjustments being made accordingly.

Also described are novel apparatus for molding a predetermined shape onto the end of an optical fiber having a core. The apparatus includes a mold having one or more surfaces being configured and dimensioned to impart a predetermined shape to an end of an optical fiber contacted therewith, the core of the optical fiber being precisely located with respect to the predetermined shape. The apparatus further includes means for heating the mold, and, optionally, means for cooling the end of the optical fiber and/or means for monitoring the position of the end of the optical fiber relative to the mold.

Also described are novel apparatus having a substrate with an optical device and a novel optical fiber have a molded shape at an end thereof mounted thereon, the molded shape being precisely located with respect to the core, the molded shape being formed by axial compression of the fiber with a mold, wherein the molded end face is optically coupled to the optical device.

### BRIEF DESCRIPTION OF DRAWINGS

FIG. 1 is a schematic view of an optical fiber and wedge-shaped mold having planar sloped sidewalls prior to contacting.

FIG. 1A is a schematic view of an optical fiber and wedge-shaped mold having planar sloped sidewalls and a recess at the base of the mold prior to contacting.

FIG. 2 is a schematic cross-sectional side view of an optical fiber and two-part wedge-shaped mold.

FIG. 3 is a schematic view of an optical fiber and two-part wedge-shaped mold showing those areas of the fiber and/or mold that can be heated prior to or during the contacting.

FIG. 4 is a schematic view of an optical fiber and two-part wedge-shaped mold showing various cooling means useful herein.

FIG. 5 is a schematic cross-sectional side view of an optical fiber and a mold consisting of two cylindrical rods.

FIG. 6 is a schematic view of an optical fiber tip being contacted with a mold formed by cylindrical shaped rods.

FIG. 7 is a schematic view of an alternative embodiment of the mold formed by cylindrical shaped rods wherein the gap spacing is provided by coating one or both of the rods to define a recess.

FIGS. 8-12 are schematic views of various apparatus for molding an optical fiber tip wherein the fiber is heated using plasma discharge.

FIG. 13 is a schematic view of a fiber having a tip formed by prior art methods and a mold formed by cylindrical shaped rods prior to contacting.

FIG. 14 is a schematic view of an apparatus for molding an optical fiber tip wherein active feedback control of the molding process is employed.

FIG. 15 is a schematic view of an optical fiber with molded tip as described herein.

FIG. 16 is a schematic view of an apparatus for optically coupling an optical fiber with molded tip as described herein with an optical device.

### DETAILED DESCRIPTION

Novel optical fibers with tips shaped by molding are described herein. These novel optical fibers are particularly useful for receiving light emitted from a device having a noncircular beam shape, such as, for example, light emitted from edge-emitting semiconductor lasers.

Methods for making the novel optical fibers with tips shaped by molding are also described. Methods according to this disclosure consistently result in optical fibers having a waveguide core that is precisely located with respect to the shaped tip. Also described are novel apparatus having substrate mounted thereon an optical device and a novel optical fiber have a molded shape at an end thereof, the molded shape being precisely located with respect to the core, the molded shape being formed by axial compression of the fiber with a mold, wherein the molded face is optically coupled to the optical device.

Optical fibers are extremely thin filaments of glass or plastic. The term “glass” as utilized herein is intended to refer to transparent, amorphous, inorganic materials such as, e.g., substances produced by fusing silicates, borates, phosphates, etc., with certain basic oxides. Therefore, “glass” materials are referred to in the broadest sense and include, e.g., fused silica, fused quartz, high-purity glass, etc. A review of optical fibers can be found in the Encyclopedia of Chemical Technology, Vol. 10, pp. 125-147 (1980), the contents of which are incorporated by reference herein.

Optical fibers useful for the transmission of information include a glass core material having a first predetermined index of refraction and a glass cladding material having a second predetermined index of refraction. When viewed in cross-section, an optical fiber can be considered to have an end face. Because of the spatial relationship of the cladding material to the core material, the end face can be considered as having certain defined regions. As utilized herein, the expression “peripheral region” or similar expressions of like import is intended to refer to those areas of the end face that tend to be away from the center of the optical fiber core. Thus, the expression “central region” and other expressions of like import as utilized herein is intended to refer to those areas of the end face that are closer to the center of the optical fiber core. The glass core material may be any of those commonly known to those skilled in the art, e.g., high-purity glass, single crystals drawn into fibers, fused silica or quartz, etc. To promote the propagation of light within the core region of the optical fiber, the index of refraction of the core material is typically higher than that of the cladding glass. However, it is also known to incorporate certain laser amplifying material(s) into the fiber. Fibers such as these are useful for gain guiding of light and may have a cladding with a higher refractive index than the core material. Methods for the production of optical fibers are within the purview of those skilled in the art. Any known method can be employed for generating the optical fiber whose tip is to be subsequently shaped in accordance with the methods described herein.

It should be understood that although reference is made to particular embodiments of optical fibers made from silica-based materials, the fibers and methods described herein are suitable for use in forming shaped tips of any optical fiber material that is plastically deformable, such as, for example, in response to application of pressure and/or heat. Also, although the optical fibers schematically shown in the figures are generally cylindrical (or circular in cross-section), the present disclosure is not limited to fibers of any particular cross-sectional configuration. The methods described herein can be readily adapted by those skilled in the art for use in modifying the tips of fibers having other cross-sectional geometries, including, but not limited to, elliptical, bow-tie, tapered, and planer or flat slab wave guides. Such fibers/waveguides are commercially available for a variety of applications.

The tip of the optical fiber is shaped according to the present disclosure by contacting the optical fiber containing a waveguide core with a mold. Contacting can occur by moving a fiber into contact with a substantially stationary mold, moving the mold into contact with a substantially stationery fiber or a combination thereof. Preferably, the fiber is axially compressed into the mold. It should be understood that the step of contacting the fiber with the mold can be repeated any number of times, e.g., at least two times, until an optical fiber tip of the desired shape results. In one embodiment of the present disclosure, the face of the optical fiber end is axially compressed against the mold, e.g., by contacting the peripheral surfaces of the optical fiber with the sloping sidewalls of a stationary mold. In another embodiment of the present disclosure, an opening or recess is maintained at the region of the mold where the sloping sidewalls of the mold would otherwise converge. In this embodiment, peripheral portions of the fiber face are advantageously contacted with a mold surface without substantially contacting the central portion of the fiber face with a surface of the mold. Therefore, it should be understood that the tip of the optical fiber may not acquire the exact shape of the mold. Rather, the tip of the optical fiber is contacted with only that portion of the mold surface necessary to impart the desired shape. For example, if the mold is configured sloping sidewalls that converge at an appropriately steep angle, the central portion of the end face of the fiber would not be expected to be shaped by contact with the converged sidewalls but rather by the surface tension forces acting on the molten fiber material.

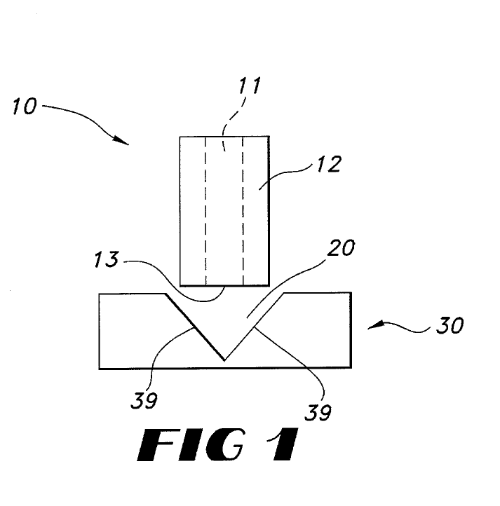

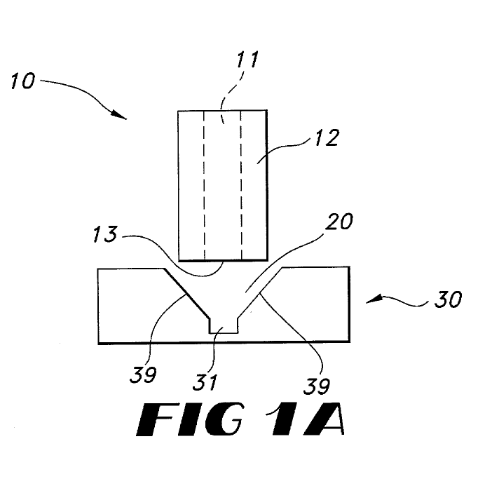

Turning now to FIG. 1, an optical fiber 10 including cladding 12 and core 11 is schematically illustrated just prior to its contacting with the shaped cavity or recess 20 of mold 30. Mold 30 can be made of any material capable of imparting a desired shape to the tip 13 of optical fiber 10. Thus, the choice of material of construction for mold 30 will depend on a number of factors including the composition of the optical fiber and the conditions under which molding thereof can be accomplished. Preferably the mold is made of a material that does not adhere to or chemically react with the optical fiber during molding.

The mold is dimensioned and configured to impart a desired shape to the optical fiber tip. For example, in the embodiment shown in FIG. 1, mold 30 includes a wedge-shaped recess 20 defined by the sloping sidewalls 39 of the mold. The sloping sidewalls 39 can be any desired shape, for example, flat, curved, cylindrical, etc., and combinations thereof. A wedge-shaped recess allows for the formation of a wedge-shaped optical fiber tip that is particularly useful for coupling with, for example, edge-emitting semiconductor lasers that emit radiation in an elliptical pattern. The mold can also be dimensioned and configured to impart any other shape to the tip of the optical fiber. Non-limiting examples of other shapes include hemispherical, elliptical, conical, pyramidal, e.g., 3-sided pyramidal, 4-sided pyramidal, etc., or any other polygonal shape. Irrespective of cross-section geometry, the mold is normally dimensioned and configured to impart a generally tapered shape to the tip of the optical fiber. The mold can also be dimensioned and configured to provide improved manufacturing characteristics. For example, a recess 37 can be provided at the base of the mold as shown in FIG. 1A. The recess 37 can be shaped such that a central region of the fiber never contacts the mold surface.

The pressure or rate of application of pressure between the optical fiber tip and the mold during the contacting step is preferably carefully controlled during the processes described herein. Empirical observation will allow modification of the pressure or rate of application of pressure between the optical fiber tip and the mold during the contacting step to obtain a desired result. Molding slowly allows for corrections to be made to the orientation of the components being contacted while the tip is being shaped. Empirical observations can be made during the contacting step to ensure the accuracy of fiber positioning with appropriate adjustments being made accordingly. For example, the contact of the fiber with the mold can be observed visually. As another example, a light source can be provided to ensure alignment of the axis of the optical fiber with the mold as described more fully below. Other methods for monitoring the contacting step will be apparent to those of ordinary skill in the art.

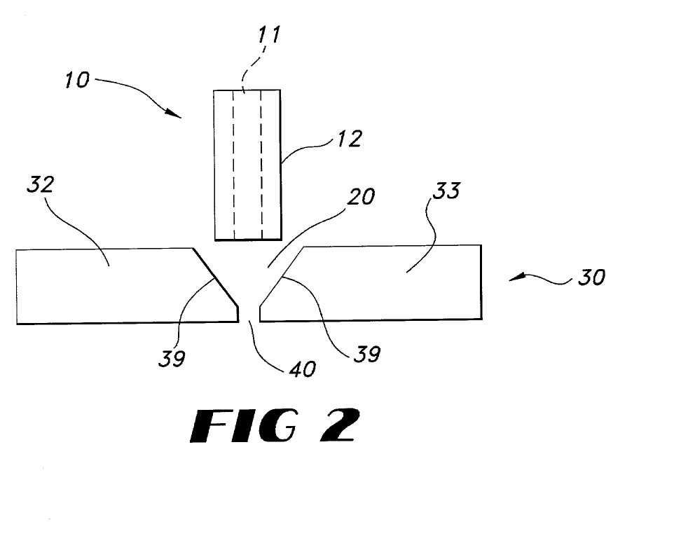

FIG. 2 schematically illustrates a particularly useful embodiment of the present method. Specifically, in FIG. 2 an optical fiber 10 including cladding 12 and core 11 is schematically illustrated just prior to its contacting with a wedged-shaped cavity or recess 20 formed by two opposing halves 32, 33 of mold 30. The wedged-shaped halves 32, 33 of mold 30 are positioned such that an opening 40 is maintained therebetween. Opening 40 is preferably about 1-5 times the size of the optical fiber waveguide core 11. Opening 40 provides a pathway for optical access to the fiber to allow monitoring of the position of the fiber during molding as discussed in more detail below.

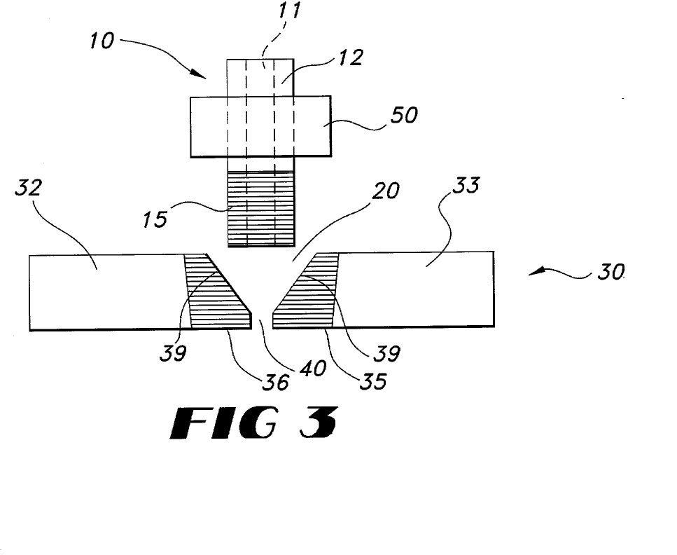

In particularly useful embodiments, the mold or the optical fiber or both are heated before and/or during the contacting step. FIG. 3 is a schematic view of an alternative embodiment of a system for molding an optical fiber 10 wherein shaped halves 32, 33 of mold 30 include regions 35, 36that are heated before and/or during the contacting step. In FIG. 3, a portion 15 of the optical fiber 10 that can also be heated is identified. Shaped-halves 32, 33 of mold 30 define recess 20 into which optical fiber 10 can be inserted. Ferrule 50 provides means for controlling the contacting of the optical fiber 10 with the recess 20. That is, ferrule 50 is secured to fiber 10 and provides structure to be engaged by positioning means (not shown) that either maintains the fiber in a substantially stationary position or moves the fiber into contact with the mold. The positioning means is able to move the fiber in an axial and/or radial direction. Where the fiber moves, positioning means can be pneumatically, hydraulically, piezo, or motor activated and computer controlled to provide precise movement of the fiber. Ferrule 50 optionallyprovides a means for cooling the optical fiber 10 after the desired shape is achieved, as more fully described below.

In embodiments where heating of the mold is employed, the mold is preferably made of a rigid material capable of withstanding the temperatures encountered during molding of the core material. Where the core 7 7 is made of silica, refractory materials can be used to form the mold. Refractory materials are well known to those skilled in the art. A discussion of various refractory materials can be found in the Encyclopedia of Chemical Technology, Vol. 20, pp. 1-64 (1982), the contents of which are incorporated by reference herein. Specific examples of suitable high temperature materials include, but are not limited to, graphite, glassy carbon, boron carbide, boron nitride, platinum alloys, combinations thereof, etc. Preferably the mold is made of a material that does not adhere to the optical fiber material at the temperatures encountered during molding. If the mold material is made of reactive (e.g., oxidizable) material, molding can be performed in an inert, non-reactive, or reducing atmosphere. In a preferred embodiment, the mold is made of pyrolytic graphite or glassy carbon. Alternatively, the mold can be made of a refractory material coated with a coating material such as, e.g., pyrolytic graphite, glassy carbon, boron nitride, combinations thereof, etc. In this manner, the coated mold will not stick or react with the optical fiber material at the temperature at which molding takes place. Techniques for coating molds are within the purview of one skilled in the art and are not part of the present disclosure.

It should be understood that the temperature of the optical fiber tip can be raised by heating the fiber, the mold or both. For example, the fiber can be heated while the mold remains substantially at room temperature prior to molding. Alternatively, the mold can be heated while the fiber remains at substantially room temperature prior to molding. Of course, any combination or variation of temperature between the optical fiber tip and the mold is envisioned as being within the scope of this disclosure. Where the fiber is heated, only the portion of the fiber immediately adjacent to the tip portion to be shaped need be heated. Typically, only the terminal 100-500 microns of the optical fiber need be heated. In embodiments where the mold is heated, the mold is preferably heated to at least about 500 to about 750° C.

Any known heating technique can be employed to raise the temperature of the tip of the optical fiber. Suitable techniques include inductive, conductive and radiant heating techniques. For example, if the mold is to be heated, an electrical current can be passed therethrough to inductively raise the temperature of the mold. Where the tip of the optical fiber is to be heated, a stream of heated inert gas can be directed at the tip of the fiber. As yet another example, electrical plasma discharge can be employed to heat the tip of the fiber. Other heating techniques will be apparent to those skilled in the art such as, for example, using a laser of suitable wavelength or flame (e.g., hydrogen flame). A description of various heating methods useful herein can be found in U.S. Pat. Nos. 4,231,777; 4,477,244; and 5,772,720 the contents of which are incorporated by reference herein.

The temperature to which the optical fiber and/or mold are heated will vary depending upon a variety of factors including, for example, the materials from which the fiber is made, the material(s) from which the mold is made, the duration of contact between the fiber and the mold, the force with which the fiber is contacted with the mold, and the desired shape to be imparted to the tip of the optical fiber. Generally, the temperature of the optical fiber tip is raised (by heating the fiber, the mold or both) to a temperature at which the core of the optical fiber will plastically deform upon application of force. Optionally, the temperature of the optical fiber tip is raised (as described above) to a temperature at which a central region of the fiber tip is shaped primarily by surface tension forces and not by contact of the central region with a mold surface. Where the core of the optical fiber is made from a silica-based material, the temperature of the tip of the fiber should be raised to the range of from about 1000 to about 3000° C., preferably from about 1400 to about 2500° C.

Where both the fiber and the mold are heated, the optical fiber tip does not have to be the same temperature as the mold. For example, the optical fiber tip can be heated to a temperature about 200-800° C. higher than the temperature of the mold. The difference in temperature between the optical fiber tip and the mold allows for the optical fiber material to flow when it contacts the mold. The fiber material only flows for a limited time. The time that the optical fiber material is flowable depends upon such variables as, e.g., the working temperature of the material, the temperature of the optical fiber tip, and the temperature of the mold.

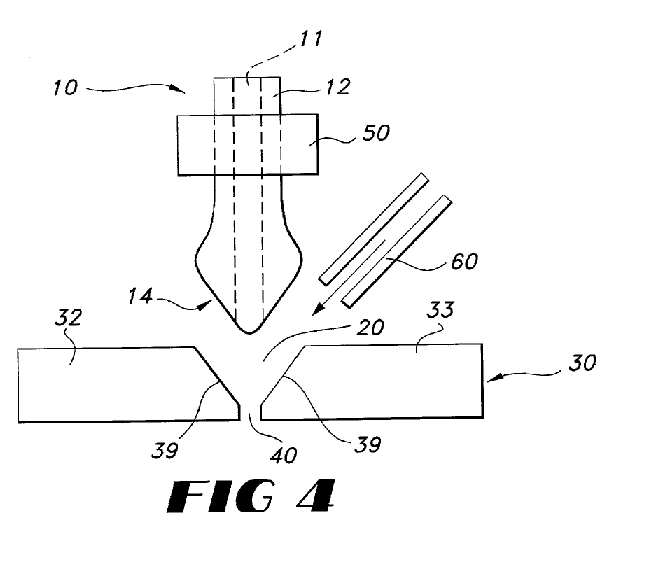

Once the optical fiber tip has acquired the desired shape (as determined by monitoring of the far-field radiation pattern or by empirical process characterization), the optical fiber tip is cooled by any suitable means known to those skilled in the art. For example, convection of the heat to the surrounding work area may in certain embodiments provide adequate cooling. When a more rapid rate of cooling is desirable, heat from the optical fiber can be transferred to a cooling material circulated adjacent to the fiber, for example, circulating suitable cooling fluid through a ferrule, An example of a suitable cooling fluid would include but not be limited to liquid, such as, for example, water. In alternative embodiments, cooling means can comprise a jet of cooling gas, e.g., cold nitrogen, applied to the mold and/or optical fiber tip after the optical fiber tip has achieved the desired shape. Of course, any combination of means for cooling can be used to the practice the methods described herein. For example, FIG. 4 schematically illustrates a combination of cooling means useful for cooling the molded optical fiber tip 14. Ferrule 50 is adapted in this embodiment to have a cooling material circulated through it. Heat exchange between the fiber and the fluid circulating within the ferrule provides cooling. In addition, one or more nozzles 60 can be positioned to direct a cooling gas or fluid (e.g., cold nitrogen) onto a molded optical fiber tip 14 and/or the recess 20 to provide cooling.

Depending upon the method of heating and/or the rate at which the core is heated, diffusion of silica or dopant can be expected to occur. Such diffusion results in the formation of a thermally expanded core. A discussion of optical fiber having a thermally expanded core can be found in U.S. Pat. No. 5,594,825, the contents of which are incorporated by reference herein. When desirable, the conditions at which the shaped fiber tips are formed can be controlled to provide a shaped optical fiber tip having a thermally expanded core.

In an alternative embodiment, the mold consists of parallel rods. In a preferred embodiment, the rods are cylindrical in shape. When the mold consists of parallel rods, the rods can be positioned either in contact with each other or distanced apart to provide a gap between the rods. The position of the rods with respect to each other can be maintained by mechanically affixing the rods in any desired position to supporting means. The gap is preferably wider in at least one dimension than the diameter of the waveguide core. Although not critical, the gap between the rods is typically in the range of about 5 to about 75 microns, more preferably about 10 to about 50 microns wide.

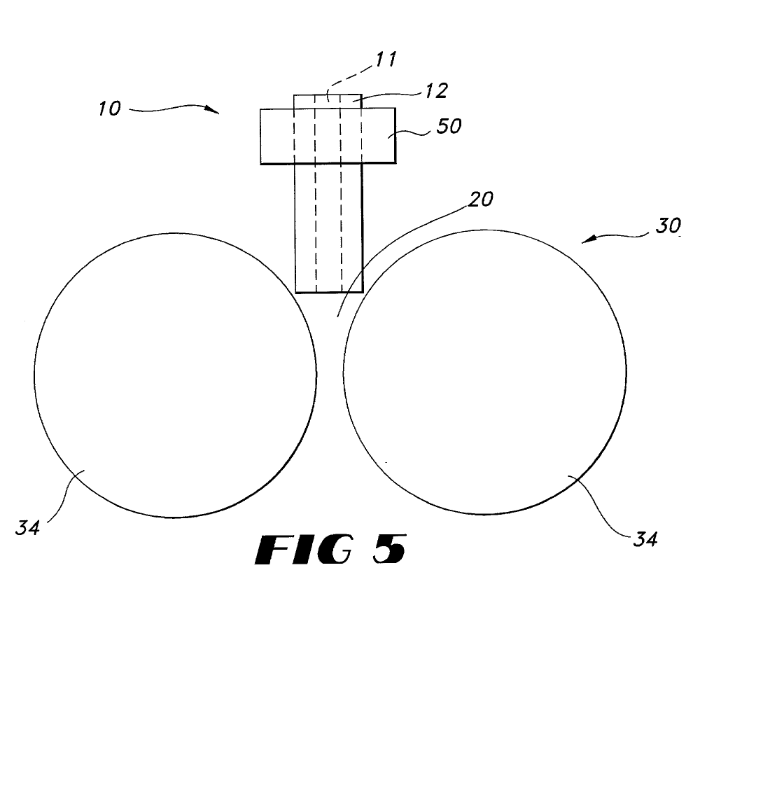

FIG. 5 schematically illustrates an embodiment wherein the mold 30 consists of cylindrical rods 34. The rods 34 are positioned to produce a gap defining recess 20. To mold the tip of the optical fiber the fiber /0 is contacted with rods 34. Rods 34 can be of any suitable diameter, with rods measuring between about 250 microns to about 3,000 microns in diameter being particularly useful. In this embodiment, in addition to providing a cooling means, the ferrule 50 can also serve as a mechanical stop for limiting the extent of insertion of the optical fiber 10 into the recess 20 defined by the gap formed by the placement of the cylindrical shaped mold rods 34.

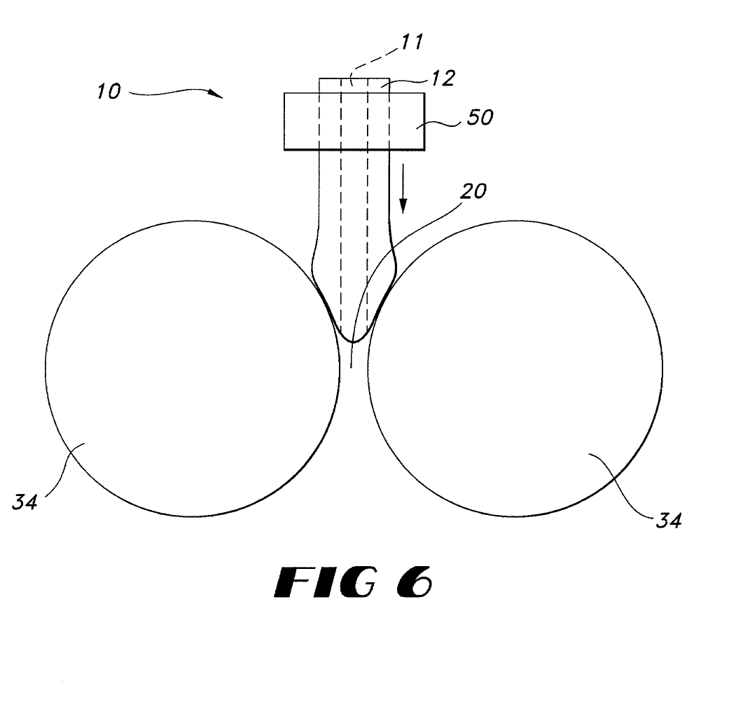

FIG. 6 is a schematic view of an optical fiber 10 being molded by contact with recess 20 formed by the cylindrical mold rods 34. The arrow represents the force vector applied through the ferrule 50 for advancing the optical fiber /0 into the defined recess 20.

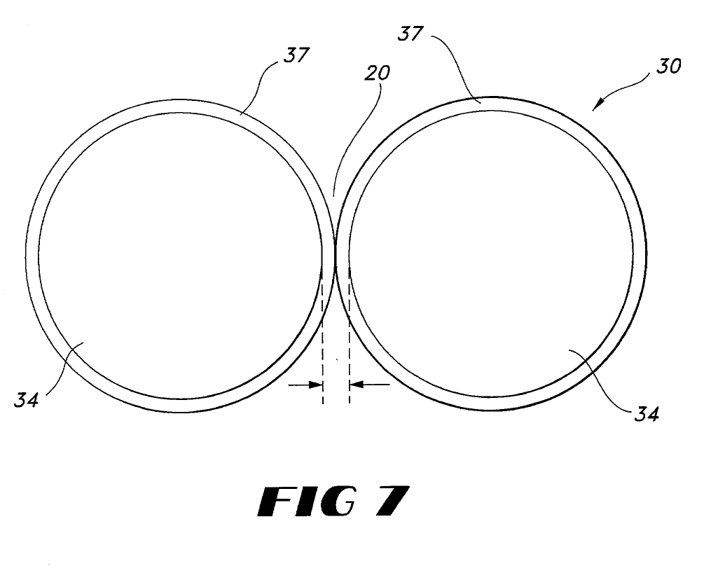

Alternatively, the gap spacing between the rods can be achieved by providing a determined thickness of a coating to a determined location on one or more of the rods. FIG. 7 is a schematic end view of mold 30 consisting of rods 34 with a coating 37 applied thereto. Coating 37 can be ceramic or any other suitable heat resistant material, e.g., boron nitride or other insulator or combinations thereof. Coating 37 is applied to rods 34 discontinuously along the length of the rods 34 to provide circumferential areas having no coating. These areas of the exposed rods 34 provide a recess 20 into which the optical fiber can be inserted for molding. It should be understood that if coating 37 is applied to both rods 34, then the width of recess 20 will be the sum of the thickness of coatings 37. Because the optional coating applied to the rod (s) to maintain the desired gap spacing is not intended to contact the optical fiber tip during is molding process, it is not critical for this coating to be of a material that is non-adherent to the optical fiber material at the temperature at which the contact molding takes place.

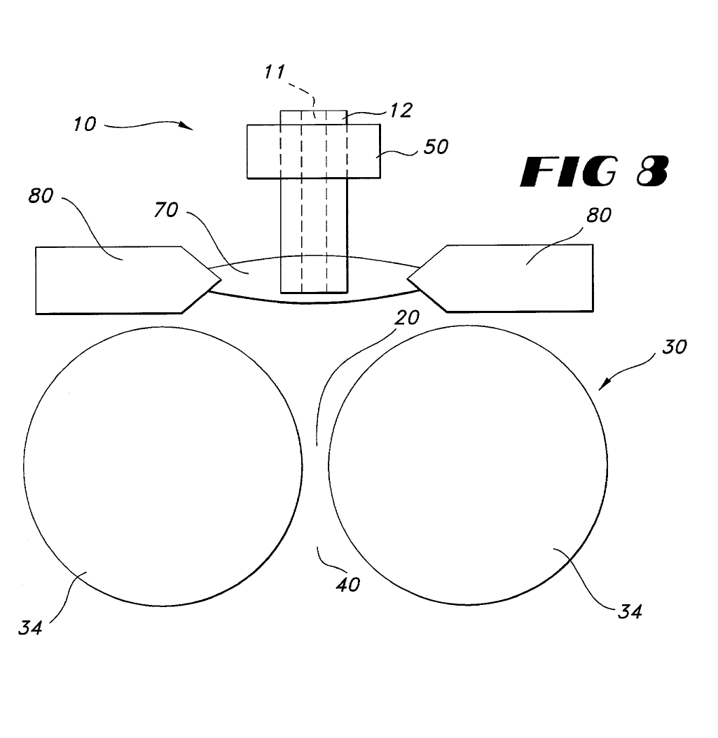

As noted above, the terminal portion of the fiber can be heated prior to contact with the mold. FIG. 8 represents an embodiment of the disclosure wherein the optical fiber 10 is heated by contact with a plasma discharge 70 produced by electrodes 80. Techniques for the production of plasma discharge are within the purview of those skilled in the art. One suitable method for generating plasma discharge is using electrodes of the type commonly used in a fusion splicer such as that described in U.S. Pat. No. 4,274,707 the contents of which are incorporated by reference herein. As fiber 70 approaches the mold 30, it passes into the plasma 70 and the temperature of the fiber is raised. If desired, movement of the fiber can be controlled to allow the fiber to dwell within the plasma for a given period of time. After being heated by the plasma 70, the optical fiber 10 is then contacted with the recess 20 defined by the rods 34. In this embodiment, the mold 30 can be heated or can be at room temperature.

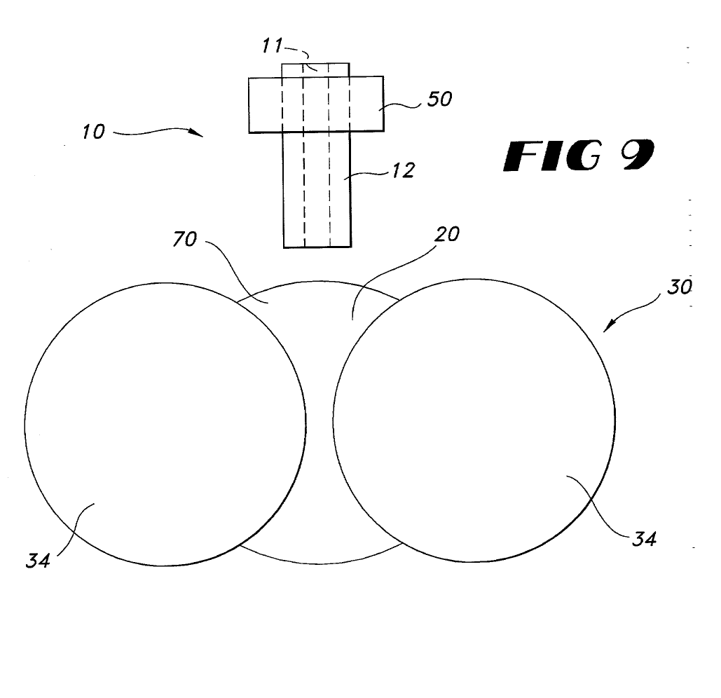

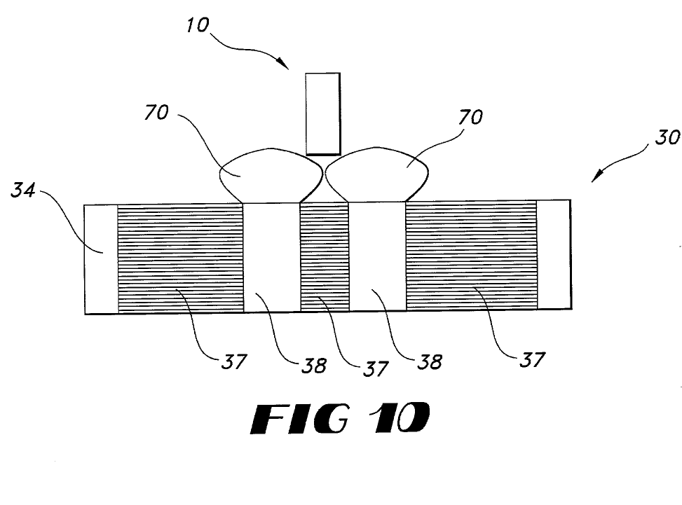

FIG. 9 is a schematic end view of an alternative embodiment using a plasma discharge 70 formed by appropriate electrodes (not shown in this view). In this embodiment, the plasma discharge 70 is limited to the regions adjacent to the recess 20 where the optical fiber 70 contacts the mold 30. FIG. 1 0 is a side view of the above embodiment wherein rods 34 (only one shown) are made of a conductive material. In this embodiment the rods 34 are coated with a nonconductive material 37 such as, e.g., boron nitride or other insulatoror combinations thereof, leaving uncoated regions 38 that are able to promote formation of a plasma discharge 70.

Also, it is noted that the coating 37 and uncoated areas 38 of the mold 30 can be switched if the rods 34 are made of nonconductive material and the coating 37 is made of conductive material (e.g., graphite or platinum). It is further noted that if a plasma discharge 70 is used to heat the fiber 10 before contact with the mold 30, the mold 30 can be at any temperature, including room temperature. Alternatively, the mold 30 can be maintained above ambient temperature, for example, at about 1000° F.

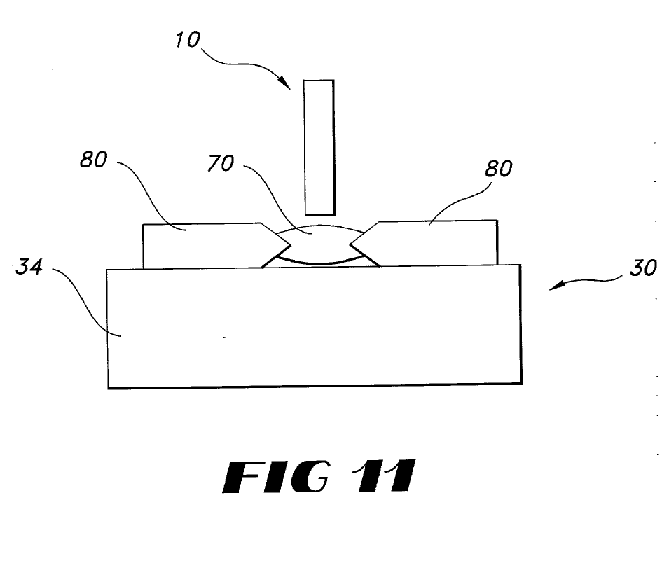

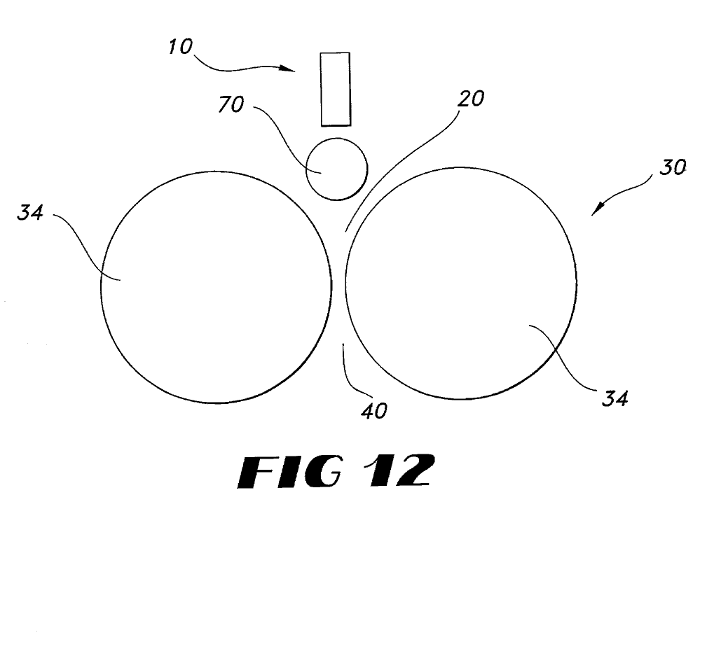

FIG. 11 illustrates a further embodiment wherein the plasma discharge electrodes 80 are oriented parallel with the rods 34 (only one shown) forming mold 30 and located just above the mold 30. In this embodiment, the mold 30 can be heated or unheated. As described above, as the fiber 70 approaches the mold 30, it passes into the plasma 70 and the temperature of the fiber is raised. FIG. 12 is an end view of the embodiment described in FIG. 11.

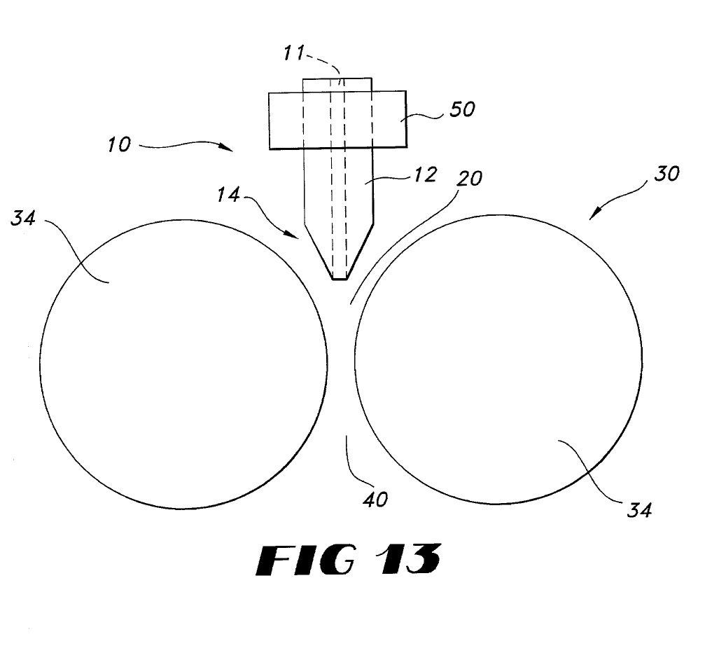

It is also possible to use a further embodiment herein to correct inadequately shaped tips prepared according to prior art methods. FIG. 13 is a schematic representation of an embodiment wherein prior to contacting the tip 14 with the recess 20 defined by mold 30, the tip 14 has a shape that is inadequate for a particular application. In this further embodiment, the shaped tip 14 of optical fiber 10 is contacted with the recess 20 until the desired shape is obtained.

In several of the embodiments described herein, the mold has an opening in its base that allows for monitoring of the spatial intensity profile of the far-field radiation emitted by the fiber during the molding of the tip of the optical fiber. In these embodiments, light can be directed through the optical fiber by coupling the end of the optical fiber that is opposite the optical fiber tip being molded with a light source. In this manner light is directed from the optical fiber while the fiber tip is being molded. Any source of light known to those skilled in the art is suitable for use according to this embodiment of the disclosure herein with the caveat that the wavelength transmitted through the fiber during molding must be detectable as compared to the wavelength(s) emitted by the incandescent optical fiber tip. In addition, the molding process may be observed using an orthogonal viewing system such as that described in U.S. Pat. No. 5,772,720, the contents of which are incorporated by reference herein. The spatial intensity profile of the far field light pattern and/or orthogonal viewing system provides a means for monitoring the shape and position of the optical fiber tip while it is being molded. In this manner empirical control can be applied by the operator to provide for optimal alignment of the optical fiber tip with the mold during the contacting step to provide a shaped optical fiber tip wherein the shape of the tip is precisely located with respect to the waveguide core.

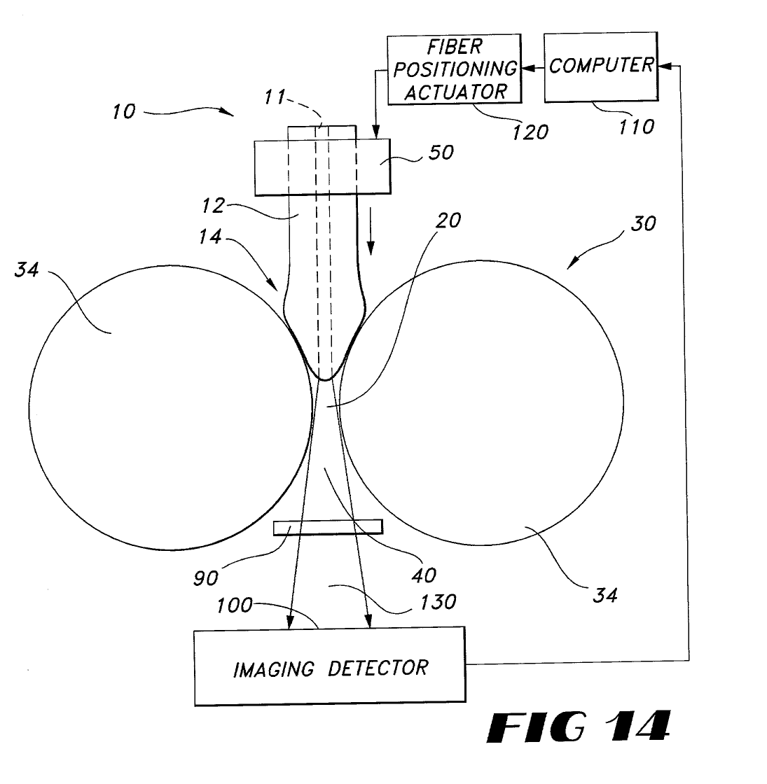

FIG. 14 is a schematic representation of a preferred embodiment that includes structure for monitoring the position of the fiber during molding and, if necessary adjusting the movement of the fiber during molding to ensure that the fiber core is precisely located with respect to the center of the shaped tip. For example, the position of the fiber core is within 3 microns of the center of the shaped end. Light 130 is directed from the optical fiber 70 during the molding process. The spatial intensity profile of the far-field light pattern is detected on an imaging detector 100. Suitable detectors are known to those skilled in the art and include, for example, charge coupled devices (CCD's), photodiode arrays, etc. The spatial intensity profile of the far-field light pattern provides for monitoring of the position of the optical fiber 10 during molding. For example, the alignment of fiber core 11 with respect to the recess 20 can be monitored. In a preferred embodiment, active feedback control is provided by computer controlled means 110 coupled to fiber positioning actuator means l20 while the fiber 10 is molded. The position of the optical fiber 70 is adjusted during the molding process to ensure that the core 11 is precisely located with respect to the center of the recess 20. Such an embodiment also advantageously provides for a desired radius of curvature of the optical fiber tip 14 or core 11 or both. In this manner, automated forming of shaped optical fiber tips wherein the waveguide core is precisely located with respect to the shape of the tip occurs. Since the optical fiber tip 14,(13 not shown in this figure) may be incandescent during the molding process, an optical filter 90 may be placed between the optical fiber and detector 100. The filter 90 will only transmit the wavelength of light passing through the optical fiber 70. Optionally, the light 130 from the fiber 10 can be modulated.

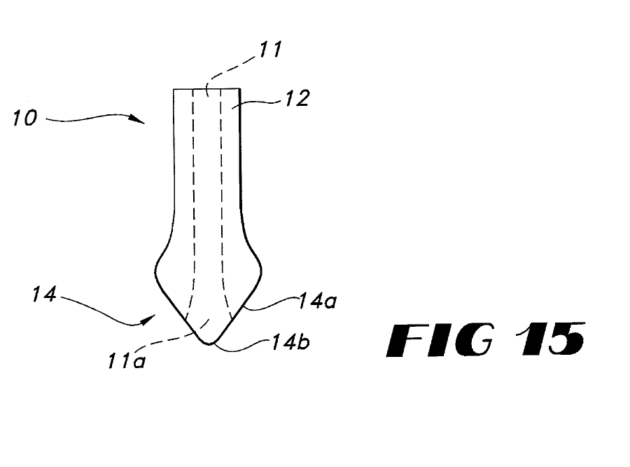

FIG. 15 is a schematic representation of an optical fiber 70 with molded tip 14 as described herein. In this embodiment, molded tip 14 contains at least two distinct regions, peripheral region 14a and central region 14b. A portion of peripheral region 14a of molded tip 14 is shaped by direct contact with a mold surface as described herein such that peripheral region 14a conforms to any pattern or shape provided by the mold surface. Central region 14b of shaped molded tip 14 however does not contact a mold surface thus acquiring its shape primarily through surface tension forces. Therefore, this central region 14b has a very smooth surface that does not require further treatment such as polishing, e.g., by fire polishing or fine lapping. In certain embodiments, the shaped molded tip 14 also contains a thermally expanded core region 11a as previously described. Thus, an optical fiber having a shaped tip is achieved efficiently and accurately by the simple process described herein.

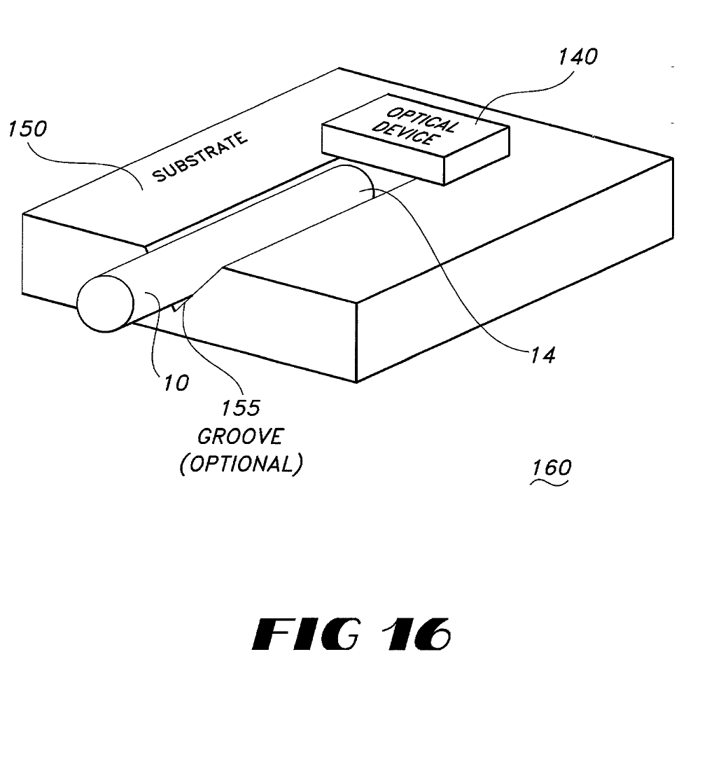

FIG. 16 is a schematic view of an apparatus 160 for optically coupling an optical fiber 10 with molded tip 14 as described herein with an optical device 140. The apparatus 160 consists of substrate 150 with optical fiber 10 and optical device 140 suitably affixed thereto. Substrate 150 can be any material known to those skilled in the art, e.g., silicon, ceramic, metal, etc. Optionally, substrate 150 has groove 155 formed therein by any suitable method known to those skilled in the art, e.g., an anisotropically etched V-groove in silicon, for holding optical fiber 70 with molded tip 14 in suitable proximity to optical device 140. Optical device 140 can be any optical device known to those skilled in the art, e.g., laser, edge-emitting semiconductor laser, light emitting diode, photodetector, microoptical component, filter or the like. Preferably, the optical device is an edge-emitting semiconductor laser as previously described. Thus, an optical submount chip having disposed thereon an optical fiber having a shaped tip efficiently and accurately optically coupled with an optical device is provided.

It will be understood, by those skilled in the art, that various modifications can be made to the disclosure herein. For example, it is possible to vary the shape of the optical fiber tip by varying the force or forces applied during contacting the tip with the mold. That is, for example, the optical fiber can be rotated (rotated around the optical fiber axis) during the molding step. Rotating the optical fiber during the molding step will produce an optical fiber end that is rotationally symmetric. For example, pressing a fiber into a mold comprised of two parallel rods produces a wedge-shaped fiber tip; rotating the optical fiber while pressing into this same mold will produce a rotationally symmetric (e.g. conical) fiber tip. As another example, it is also possible to vary the shape of the optical fiber tip by varying the angle of contacting the tip relative to the mold or to vary the angle of contacting the mold relative to the tip. Such modifications are envisioned as being within the scope and spirit of the disclosure as described in the foregoing specification and defined in the claims appended hereto.

1. A method for shaping an end of a glass optical fiber, the optical fiber having a core therein, the method comprising:
A) heating at least one of an end of the glass optical fiber and a mold having sloping sidewalls, the sloping sidewalls defining a recess of predetermined shape;
B) axially compressing the end of the optical fiber into the mold; and
C) maintaining the end of the optical fiber in contact with the mold until at least a portion of the fiber conforms to the predetermined shape of the recess to produce a shaped tip on the end of the fiber.

2. The method of claim 1 wherein the sloping sidewalls are flat.

3. The method of claim 1 wherein the sloping sidewalls are curved.

4. The method of claim 1 wherein the sloping sidewalls are cylindrical.

5. The method of claim 1 wherein the predetermined shape of the recess produces a shaped tip having a shape selected from the group consisting of wedge shapes, spherical shapes, conical shapes, and pyramidal shapes.

6. The method of claim 1 wherein the step of heating an end of the optical fiber comprises exposing the end of the optical fiber to electrical plasma discharge.

7. The method of claim 1 wherein the step of heating the mold comprises flowing electrical current through at least a portion of the mold.

8. The method of claim 1 further comprising the steps of:
D) directing light through the optical fiber, said light being emitted through the end of the optical fiber being shape d; and
E) monitoring a position of the core of the optical fiber relative to the mold by detecting a spatial intensity profile of the light exiting from the end of the optical fiber.

9. The method of claim 8 wherein the step of monitoring further comprises the step of adjusting the position of the fiber relative to the mold such that the core is within 3 microns of the center of the shaped end.

10. The method of claim 1 wherein the step of compressing is repeated at least a second time.

11. The method of claim 1 further comprising the step of cooling the end of the optical fiber after the fiber conforms to the predetermined shape.

12. A method for shaping an end of an optical fiber, the optical fiber having a core therein and an end face comprising a peripheral region and a center region, the method comprising:
A) heating at least one of an end of the optical fiber and a mold having a recess of predetermined shape, the predetermined shape having sloping side walls;
B) axially compressing the end of the optical fiber with the mold such that the peripheral region of the optical fiber end face contacts at least a portion of the sloping sidewalls with the center region of the optical fiber end face not being in contact with the mold surface; and
C) maintaining the end of the optical fiber in contact with the mold until at least a portion of the fiber conforms to the predetermined shape of the recess to produce a shaped tip on the end of the fiber.

13. The method of claim 12 wherein the sloping sidewalls are flat.

14. The method of claim 12 wherein the sloping sidewalls are curved.

15. The method of claim 12 wherein the sloping sidewalls are cylindrical.

16. The method of claim 12 wherein the recess of predetermined shape produces a shaped tip having a shape selected from the group consisting of wedge shapes, spherical shapes, conical shapes, and pyramidal shapes.

17. The method of claim 12 wherein the step of heating an end of the optical fiber comprises exposing the end of the optical fiber to electrical plasma discharge.

18. The method of claim 12 wherein the step of heating the mold comprises flowing electrical current through at least a portion of the mold.

19. The method of claim 12 further comprising the steps of:
D) directing light through the optical fiber, said light being emitted through the end of the optical fiber being shaped; and
E) monitoring a position of the core of the optical fiber relative to the mold by detecting a spatial intensity profile of the light exiting from the end of the optical fiber.

20. The method of claim 19 wherein the step of monitoring further comprises the step of adjusting the position of the fiber relative to the mold such that the core is within 3 microns of the center of the shaped end.

21. The method of claim 12 wherein the step of compressing is repeated at least a second time.

22. The method of claim 12 further comprising the step of cooling the end of the fiber after the fiber conforms to the predetermined shape.

23. A method for forming a shaped tip on an end of a glass optical fiber having a core, method comprising:
A) heating at least one of an end of the optical fiber and a mold having sloping sidewalls, the sloping sidewalls defining a recess of predetermined shape; the recess of the mold having an opening at the base thereof;
B) axially compressing the end of the optical fiber into the mold;
C) directing light through the optical fiber, said light being emitted through the end of the optical fiber being shaped;
D) monitoring the position of the core of the optical fiber relative to the mold by detecting a spatial intensity profile of the light exiting from the end of the optical fiber; and
E) maintaining the end of the optical fiber in contact with the mold until at least a portion of the fiber conforms to the wedge-shaped recess of the mold.

24. The method of claim 23 wherein the sloping sidewalls are flat.

25. The method of claim 23 wherein the sloping sidewalls are curved.

26. The method of claim 23 wherein the sloping sidewalls are cylindrical.

27. The method of claim 23 wherein the step of compressing is repeated at least a second time.

28. A glass optical fiber having a core and an end face comprising a peripheral region and a central region, the end face of the optical fiber having a molded shape, the molded shape being formed by axial compression of the fiber with a mold.

29. The glass optical fiber of claim 28 wherein the end face of the optical fiber has a sloped shape formed by axial compression of the fiber face against a mold with sloping sidewalls.

30. The glass optical fiber of claim 28 wherein the molded shape is a shape selected from the group consisting of wedge, spherical, conical, and pyramidal shapes.

31. The glass optical fiber of claim 28 wherein the core is within 3 microns of center of the molded shape of the optical fiber end face.

32. The glass optical fiber of claim 28 wherein the central region of the optical fiber end face is shaped primarily by surface tension.

33. An apparatus for molding a predetermined shape onto an end of a glass optical fiber having a core, the apparatus comprising:
a mold;
one or more surfaces of the mold being configured and dimensioned to impart a predetermined shape to an end of the glass optical fiber contacted therewith.

34. The apparatus of claim 33 further comprising means for heating at least one of the mold and the optical fiber.

35. The apparatus of claim 34 wherein the means for heating comprises electrodes for plasma discharge.

36. The apparatus of claim 33 further comprising means for cooling the end of the optical fiber.

37. The apparatus of claim 36 wherein the means for cooling the end of the optical fiber comprises a ferrule surrounding a portion of the optical fiber, the ferrule adapted to pass cooling fluid therethrough.

38. The apparatus of claim 36 wherein the means for cooling the end of the optical fiber comprises a nozzle for directing a stream of cooling gas toward the end of the optical fiber.

39. The apparatus of claim 33 further comprising means for monitoring the position of the end of the optical fiber relative to the mold.

40. The apparatus of claim 39 wherein the means for monitoring the position of the end of the optical fiber relative to the mold comprises an orthogonal viewing system.

41. The apparatus of claim 39 wherein the means for monitoring the position of the end of the optical fiber relative to the mold comprises a detector for detecting light emitted from the end of the optical fiber being molded.

42. The apparatus of claim 33 further comprising means for adjusting the position of the fiber axially relative to the mold.

43. The apparatus of claim 33 further comprising means for adjusting the position of the fiber radially relative to the mold.

44. The apparatus of claim 33 wherein the mold has a recess.

45. The apparatus of claim 33 wherein the mold has a base with an opening therein.

46. The apparatus of claim 33 wherein the mold comprises two cylinders.

47. The apparatus of claim 33 wherein the mold is made of a material selected from the group consisting of graphite, glassy carbon, boron carbide, boron nitride, platinum, platinum alloys, and combinations thereof.

48. The apparatus of claim 33 wherein the mold is coated with a material selected from the group consisting of graphite, glassy carbon, boron nitride, and combinations thereof.

49. An apparatus comprising:
a substrate,
an optical device,
a glass optical fiber disposed on the substrate having a core and an end face comprising a peripheral region and a central region, the end face of the optical fiber having a molded shape, the molded shape being formed by axial compression of the fiber with a mold,
wherein the molded face is optically coupled to the optical device.
